(19) United States
(12) Patent Application Publication
(10) Pub. No.: US 2014/0354043 A1
(43) Pub. Date: Dec. 4, 2014

(54) CONNECTION, METHOD, EQUIPOTENTIAL SHUNT CONNECTION AND EQUIPOTENTIAL BONDING CURRENT RETURN NETWORK IN A NON-CONDUCTIVE ARCHITECTURE

(71) Applicants: LABINAL POWER SYSTEMS, Blagnac (FR); MECATRACTION, Arnac Pompadour (FR)

(72) Inventors: Jean-Luc Biesse, Saint Lieux Les Lavaur (FR); Franck Albero, Plaisance du Touch (FR); Samuel Andraud, Salagnac (FR); David Boutot, Lascaux (FR)

(73) Assignees: LABINAL POWER SYSTEMS, Blagnac (FR); MECATRACTION, Arnac Pompadour (FR)

(21) Appl. No.: 14/372,802

(22) PCT Filed: Jan. 17, 2013
(86) PCT No.: PCT/FR2013/050104

§ 371 Date: Jul. 17, 2014

(30) Foreign Application Priority Data
Jan. 20, 2012 (FR) 1250597

(51) Int. Cl. H01R 3/00; H01R 43/048; H01R 43/02; H01R 43/16; B60R 16/02; H01B 1/02

(52) U.S. Cl. CPC H01R 3/00; B60R 16/0215; H01B 1/023; H01R 43/02; H01R 43/16; H01R 43/048
USPC 307/9.1; 228/101; 29/876; 29/882

(57) ABSTRACT

The object of the invention is to produce equipotential connections that are electrically efficient in terms of resistivity between portions of a current-return network in a non-conductive architecture, such as an airplane fuselage. The approach adopted by the invention is to impart an equipotential-bonding function to an aluminum cable having a large cross section, said bond being electrically connected, via direct contact, to as many devices as is physically possible to connect thereby.

According to one embodiment, an electrical connection assembly of an aircraft fuselage (100) having a composite skin comprises in-line shunt connections (2) for electrically interconnecting an aluminum-alloy-based cable (1) of large cross section acting as an equipotential connection to brackets (113, 141) for primary current-return networks and to brackets (111) for electrical devices via connectors (202). Each in-line shunt connector (2) comprises a central sleeve (2m) for directly electrically contacting the cable (1), end portions for installation on the cable (1) by crimping, and an attachment means (2p) for attaching to the bracket (111) of the device. Each of the ends of the sleeve (2m) have a seal accommodated therein. Each interconnection has two sealed regions, which surround a central contact region formed by means of window-stripping.

### TECHNICAL FIELD

The invention relates to a method for the equipotential-bonding connection of a current-return electrical cabling network in an architecture, in particular an airplane fuselage, a railway car, a building or a motor vehicle. The invention applies in particular to the electrical networks of new-generation airplanes having a skin made of a composite material. The invention also relates to an equipotential shunt connector and to a current-return network having such equipotential shunt connectors for carrying out said method in a non-conductive architecture.

The composite material of this new generation of skin has a heterogeneous carbon-fibre-based material. Traditionally, the functions of networking electrical cabling were performed by the aluminium skin of the previous generation, in particular: current return from consumer devices, setting all metalwork to the same potential, electromagnetic compatibility (EMC) protection of the electrical installation, discharging lightning currents—whether indirect or induced—and electrostatic charges.

The invention thus aims to be applicable to any structure in which the passage of electricity calls for the maintenance of at least some of these interconnection functions where the shell of the structure or architecture is non-conductive.

### PRIOR ART

Carbon composite materials are average electrical conductors and withstand poorly the heating prompted by the Joule effect. This type of coating thus cannot be used to perform the above functions.

To allow the functions of connecting electrical cabling to be carried out in a composite-skin airplane, an architecture made of metalwork is conventionally used to form an electrical network. On the whole, as shown by the cross section of an airplane fuselage 100 in FIG. 1a, this type of network is installed along structural carbon frames 102 of the fuselage 100. This fuselage, which in essence has a composite-material outer skin 101 that encases the frames 102, is made of a material that is a poor electrical conductor. More precisely, the network is formed by three longitudinal primary networks, namely:
a return network 110 in the upper portion of the fuselage, known as the “upper network”, having, inter alia, metal brackets 111 for luggage compartments, profiled cable runways 112 and a central metal bracket 113;
a “middle” return network in the middle portion 120, comprising, inter alia, profiled seat rails 121 and profiled cable runways 122; and
a return network in the lower portion 130, known as the “lower network”, based on profiled metal cargo rails 131, inter alia.

These longitudinal networks are interconnected transversely by metal cross-pieces 141 connected by structural rods 142 and by wired connections, as explained below. Current-return networks are thus networked in order to increase functional safety.

Any conductor intended to produce an equipotential connection should have the following basic properties: be an excellent electrical conductor (or, in other words, ensure performance at extremely low resistivity), have a low density so as to minimise weight, imperatively remain cost-effective and meet other technical performance requirements (service life, environmental resistance, etc.). Aluminium is the material that best satisfies all of these criteria. Equipotential connections are thus generally produced from lengths of aluminium cable of large cross section; that is of a cross section greater than that of the “AWG 10” gauge, or having a cross section greater than approximately 5 mm², selected from among the series for aeronautics.

As shown by the front-view diagram in FIG. 1b, equipotential connections are formed by this type of cable 201 by joining for example the overhead baggage compartment brackets 111 to the central bracket 113 of the upper return network on the one hand and to the metal cross-pieces 141 of the middle return network on the other hand. Between each overhead baggage compartment bracket 111 and the return-network brackets 113 or 141, no fewer than seven equivalent electrical resistances are encountered: the two resistances of the interfaces between the metal brackets 111 and 113 or 141 and the attachment terminals 202, the two electrical resistances of the terminal bodies 202, the two interface resistances between the terminals 202 and the cables 201 and the linear electrical resistance of the length of cable 201 of large cross section. Where there are overhead baggage compartment brackets 111, as in the example shown, the resistance of the conductive parts of this bracket should be added.

In order to reduce the ultimate duration of the cycle for assembling parts on the assembly line, the terminals can be replaced by unipolar connectors having a movable portion and a fixed portion. In some cases, two lengths of cable are directly connected to one another by stacking two terminals by means of a stud or a terminal strip.

When devices are located far away from the metal parts forming the brackets for the return networks, the connection of these devices to the current-return networks is done as closely as possible to these devices owing to, in particular, the need to control drops in line voltage. Such connections are generally produced by either rigid or flexible intermediate metal brackets, depending on the intensity of the loads to be transmitted simultaneously. These connections thus induce additional parasitic resistances. Fixed to these brackets are the terminals to be bonded to each portion of cable joined to an upper return network 110 and intermediate return network 120, and to the device concerned. This intermediate bracket introduces additional equivalent electrical resistances into the network as a whole, namely between the return networks, and between each return network and said equipment.

A triple junction by means of studs or terminal strips is a possible alternative to the intermediate bracket. Each stud or strip generates two equivalent electrical interface resistances between the terminals.

These solutions have the major drawback of interrupting the equipotential bond, which causes a decrease in reliability, and weight and cost gains.

Aside from the terminals and the unipolar connectors, the electrical interconnection of the cables of large cross section also uses extension leads.

However, this connection configuration, which is currently used to produce equipotential connections, was originally designed to only create end-connections for aluminium-alloy cables of large cross section. This approach leads to lengths of cable of large cross section being interconnected end to end to produce equipotential connections between the various portions of the current-return network described above.

Now, the present need, which arises in particular on the fuselages of composite-material airplanes, is for a structure of current-return networks, which is produced in a plurality of portions (namely an upper, a middle and a lower portion), to be shunt-connected via wired equipotential connections. As shown by the connection means described above in relation to intermediate portions which are disadvantageous in terms of equivalent resistance, known solutions do not allow equipotential connections to be produced that are also effective, both electrically and as far as weight, cost and reliability are concerned. Thus, the increase in the gauge of the cables of connections results in:
an increase in the weight of the cables, of the connection configuration and associated intermediate brackets;
an increase in the bill of materials cost;
an upward revision of routing costs.

### SUMMARY OF THE INVENTION

An object of the invention is thus to overcome the drawbacks of known connector means by simplifying interconnection while maintaining performance. In particular, for safety reasons, an object of the invention is to produce equipotential connections between the portions of the return network which are electrically effective in terms of low resistivity, having, for example, a total equivalent resistance in the region of a few milliohms. In addition, the invention maintains the defined interconnection functions throughout the service life of the airplane, despite the fact that the large number of cable lengths impairs the anticipated reliability of the current-return network as a whole.

The approach adopted by the invention is to impart an equipotential-bonding function on the aluminium cable of large cross section, this bond being electrically connected by direct contact to as many devices as is physically possible to connect thereby.

More precisely, the present invention relates to a method for the equipotential-bonding connection of a current-return network in a non-conductive architecture. This network comprises primary current-return networks that are remote from one another in terms of location such that equipotential connections join the primary networks so that altogether they form one current-return network. The connections are formed by aluminium cabling of large cross section that integrally forms an equipotential connection between the primary networks. The devices are electrically connected as closely as possible to their location by direct intermediate connections that succeed one another along the equipotential connection without interrupting the cabling and are produced by tight electrical and mechanical installation. Each interconnection has two sealed regions that surround a central contact region by means of window-stripping. Advantageously, the overall electrical performance of such a current-return network is optimised and maintained in terms of resistivity regardless of the number of intermediate interconnections.

According to preferred embodiments:
each connection is installed by rigid connection techniques selected from among screwing, riveting, soldering, welding, crimping and shrink-fitting;
a conductive material is applied upon sheath stripping before each interconnection is installed, in order to improve electrical contact and prevent oxidation;
alternatively, a metal surface treatment is applied;
each connection has an electrical installation region that is offset from a region for attaching the interconnection.

The invention also relates to an in-line equipotential shunt connector between an aluminium-alloy-based cable of large cross section, equipotentially bonding primary current-return networks in a non-conductive architecture, and an electrical device in this architecture. This shunt connector comprises a substantially cylindrical metal sleeve for installation on the cable by a rigid connection means and an attachment means that extends the sleeve so as to be attached to a bracket for the device. The installation sleeve is composed of two end portions that each accommodate a seal and surround a central region for electrical contact with the cable having been pre-stripped in a window formed within the central region.

According to particular embodiments:
notches are provided along at least an end portion of the sleeve to adjust its angular positioning relative to the equipotential-bonding cable prior to rigid connection;
the rigid connection means is a crimping by punch and die;
the end portions of the sleeve are crimped onto an insulating sheath of the cable using a tool of the type for aluminium terminals;
the sleeve has an inner wall coated with an anti-corrosion protective metal coating;
alternatively, the stripped core of the cable is coated with a layer of conductive grease;
a recess is formed between the sleeve and the cable, and between the stripped window of the cable and at least one seal of an end portion of the sleeve so as to be able to receive an excess of grease formed during crimping without trapping this grease between the seal and the cable;
alternatively, a channel is formed through the sleeve for injecting the amount of conductive grease so that its end is in communication with the electrical crimping region between the stripped window of the cable and the inner face of the sleeve, the crimping then being able to seal this channel after orienting the sleeve by means of notches;
the electrical crimping region is axially offset from the attachment means in the central region of the sleeve.

The inventions also relates to a current-return network comprising such equipotential shunt connectors between devices and at least one aluminium-alloy-based cable of large cross section, acting as a connection between primary networks of the current-return network so as to be able to carry out the connection method in a non-conductive architecture. The cable is connected to the brackets for the primary networks by any known means: terminals, unipolar connectors, terminal strips, etc.

### BRIEF DESCRIPTION OF THE FIGURES

Other aspects and distinctive features for carrying out the invention will emerge upon reading the following detailed description, which is accompanied by appended drawings, in which:

FIGS. 1a and 1b are cross sections of an airplane fuselage, of a current-return network and a diagram of the equipotential connections between the primary networks according to the prior art (discussed above);

FIG. 2 is a front-view diagram of an example of an equipotential-bonding connection in the form of a connection between primary networks and a device bracket according to the invention;

FIG. 3 is a diagram of equivalent electrical resistances where three devices are coupled to the connection according to the preceding drawing;

FIGS. 4a to 4d are front (4a) and plan (4b) views, a cross section (4c) and a longitudinal section (4d) of an example of a shunt connector on a connection according to the invention;

FIG. 5 is a longitudinal section of an example of a shunt connector comprising a recess for receiving the excess conductive grease;

FIGS. 6a and 6b are a longitudinal section and a plan view of an example of a shunt connector comprising an orifice for the injection of conductive grease; and

FIG. 7 is a cross section of an example of a shunt connector comprising an electrical crimping region and an attachment means, which are axially offset.

### DETAILED DESCRIPTION

Reference signs that are either the same or have a common root but are used in difference figures relate to the same or to technically equivalent elements. The terms “upper”, “middle” and “lower” refer to the relative positioning in the standard mode of use or installation. The terms “longitudinal” and “transverse” qualify elements that extend in one direction and in a plane that is perpendicular to this direction.

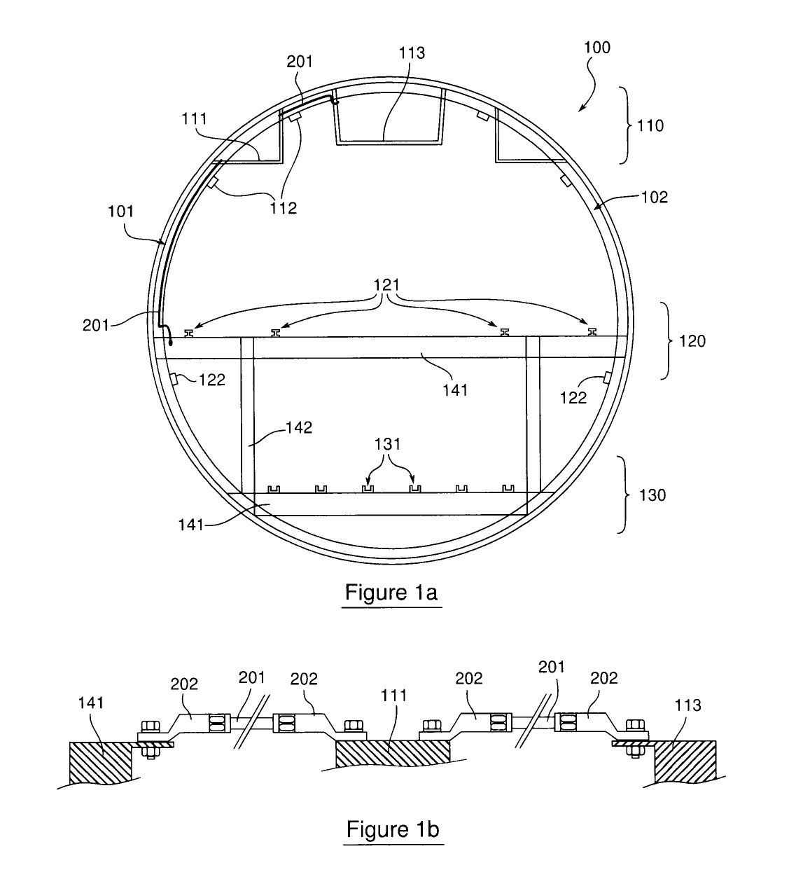

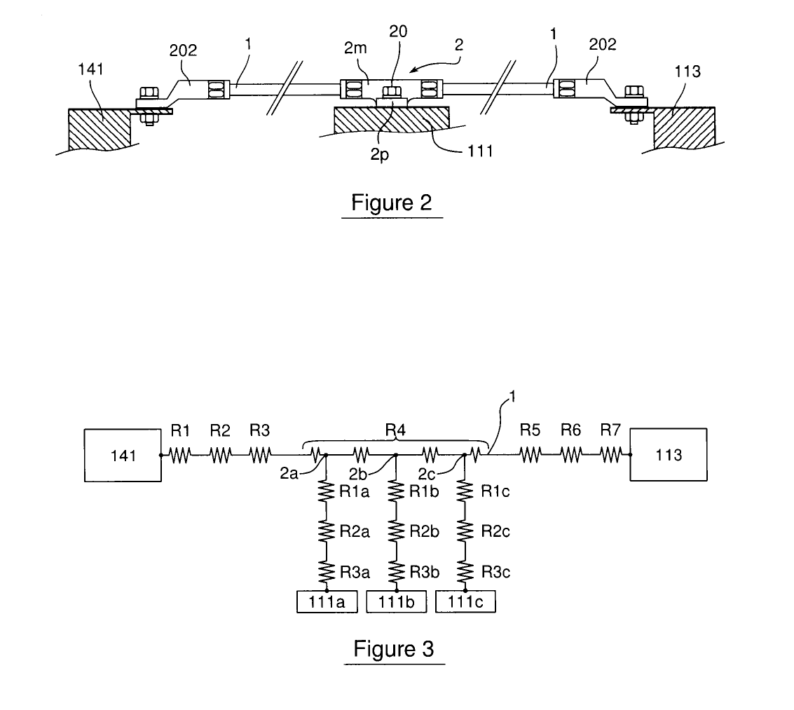

With reference to the diagram in FIG. 2, an equipotential-bonding connection is shown in the form of an aluminium-based cable 1 having a cross section of, for example, 35 mm². In the example shown, this cable 1 acts as an equipotential connection between the middle-network return 120 and the upper-network return 110 shown in FIG. 1a. The cable 1 and the metal brackets 113 and 141, which are the upper network 110 and middle network 120 respectively, are joined by the terminals 202.

A device that is close to the connection 1 and joined to the overhead baggage compartment bracket 111 is electrically interconnected to this connection by an intermediate in-line equipotential shunt connector 2 (hereinafter referred to as the “shunt connector”) between the two ends of the cable. In the example, the shunt connector 2 comprises a central cylindrical sleeve 2m and a pin 2p that is attached to the bracket 111 by a screw 20. Since the cable has not been interrupted, only three resistances are at work in this coupling: the interface resistance between the cable 1 and the shunt connector 2, the resistance of the body of the shunt connector 2 and the resistance of the interface between the shunt connector 2 and the bracket 111.

The number and value of the resistances at work in the coupling, which are typically well below milliohm, are extremely low. This bonding principle makes it possible to achieve an optimised performance in terms of total electrical resistance, which does not change, regardless of the number of intermediate interconnections. Thus, FIG. 3 shows the connection of three devices of brackets 111a, 111b, 111c to the cable 1 by the shunt connectors 2a to 2c according to an electrical diagram of equivalent resistances, where:
R1 and R7 denote the resistances of the interfaces between the terminals 202 and the upper bracket 113 and middle bracket 141 which are coupled to the cable 1 at its ends;
R3a to R3c show the resistances of the interface between the shunt connectors 2a to 2c and the brackets 111a to 111c for the devices;
R2 and R6: the resistances of the bodies of the terminals 202;
R3 and R5: the interface resistances between the cable 1 and the terminals 202;
R2a to R2c: the resistances of the bodies of the shunt connectors 2a to 2c;
R1a to R1c: the resistances of the interfaces between the cable 1 and the shunt connectors 2a to 2c; and
R4: the resistance of the cable 1 that integrally passes through all the shunt connectors 2a to 2c without interruption.

Since the connections between the brackets for the devices 111a to 111c are installed one after the other in parallel along the cable 1, there is no variation in the total electrical resistance of the connection between the ends of the cable 1 that are joined to the brackets 113 and 141. Moreover, the total electrical resistance between any of the devices and the current-return network formed by the two primary networks 110 and 120 (FIG. 2) is kept to a minimum and remains the same regardless of the number of devices.

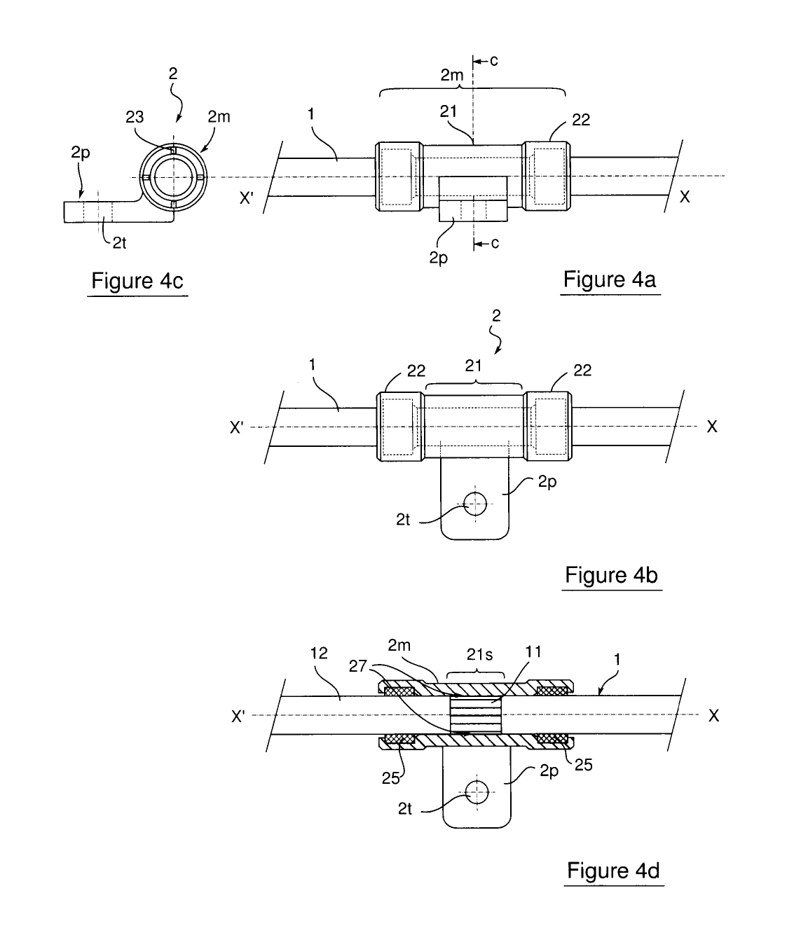

With reference to the views in FIGS. 4a to 4d, an example of a shunt connector 2 on a connection 1 according to the invention is shown in detail. It can be seen in the front and plan views in FIGS. 4a and 4b that the shunt connector 2 comprises a central region 21 that is extended at each end by a sealed region 21, these regions forming the cylindrical sleeve 2m (cf. FIG. 2). In addition, the central region 21 is extended transversely by the attachment pin 2p comprising an attachment hole 2t (through which the attachment screw 20 in FIG. 2 passes).

The cross section in FIG. 4c in the plane CC shows that there are notches 23 formed in at least one of the end regions 22. These notches make it possible to achieve the radial angular orientation of the shunt connector 2 relative to the cable 1 in accordance with the gauging information indicated on the cable.

The cross section in FIG. 4d shows the outcome of preparing the cable 1 along its axis X′X. This preparation consists in stripping the cable over a window of its core 11 by removing its insulating sheath 12 in a crimping region 21s that is centred in the region 21. The view 4d also shows the cylindrical seals 25 arranged in the end regions 22. Moreover, it appears that the attachment pin 2p is substantially aligned axially along the axis X′X with the window of stripped core 11.

Electrical crimping is then performed in the electrical crimping region 21s located in the central region 21. This crimping is of the “deep crimping” type performed in a similar manner to crimping for aluminium terminals, adapting punches and dies to the geometry of the shunt connector.

Advantageously, an anti-corrosion protective metal coating 27 is arranged on the inner wall of the shunt connector 2 in the central crimping region 21. This protection ensures excellent electrical contact between the stripped core 11 and the inner wall of the coupler.

Mechanical crimping is then carried out to seal the electrical crimping. The sealed regions 22 surrounding the seals 25 are crimped to the insulating sheath 12 of the cable 1 using a tool of the same type as that used for aluminium terminals. Thus, in the case of similar sizes, the sealing efficiency is equivalent to that required for terminals.

It might also be advantageous to use a conductive grease instead of surface treatments, for example for cables having an aluminium core without the protection of a metal surface. Such a step might also be advantageous if the cores are made of aluminium wires which are, for example, copper-coated and nickel-plated.

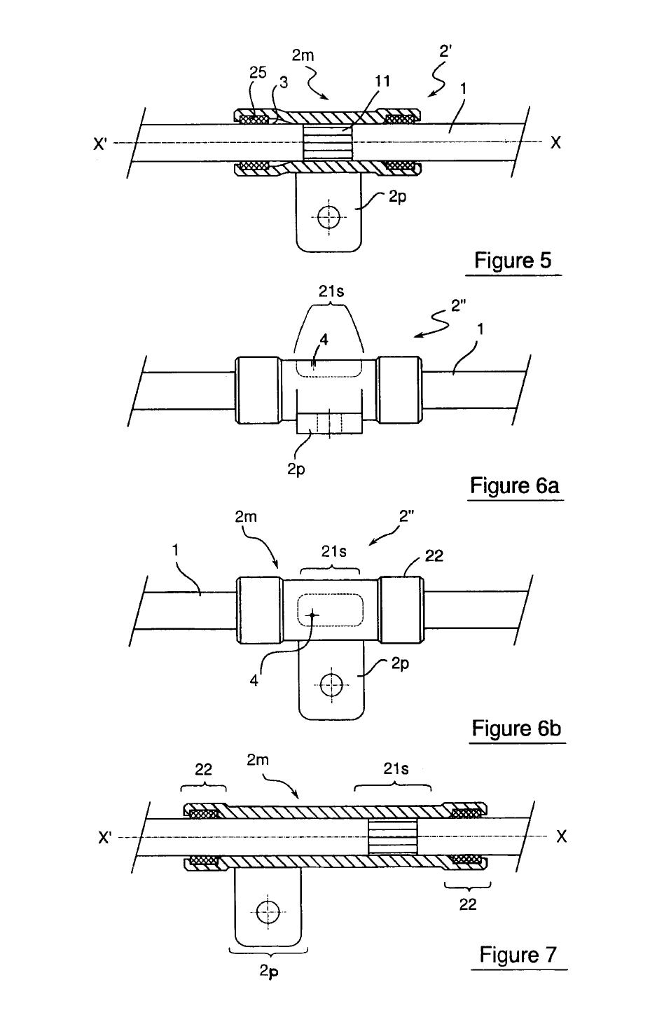

To achieve this, the stripped core 11 is pre-coated with a thin layer of a grease that conducts electricity. With reference to the longitudinal section in FIG. 5, the in-line shunt terminal 2′ is modelled so as to have a peripheral recess 3. When the coupler 2′ is installed, the surplus of grease is concentrated in the recess 3. The volume of the recess is predetermined so as to be able to receive by and large the entire potentially possible volume of grease. This recess allows the seal 25, which is arranged close to the electrical crimping region 21s and inserted in its housing, to not be crimped onto the grease. With this aim, after orientation of the coupler by means of the notches (cf. FIG. 4c), the crimping is then performed.

As an alternative to the recess, another embodiment consists in providing a grease injection channel. With reference to the sectional and plan views in FIGS. 6a and 6b, a cylindrical channel 4 passes through the shunt connector 2″ in the central region 21s, perpendicularly to its longitudinal axis X′X (merged with that of the cable 1). Alternatively, the channel may have an inclined axis. This channel 4 has a sufficient diameter for the rapid injection of the required amount of grease and to allow—after orientation of the shunt connector according to the gauging specifications and crimping of the central region 21s—this channel to be sealed by means of the displacement of material caused by this crimping operation. This sealing ensures the imperviousness of the crimping region 21s.

So as to able to reuse some tools (punches and dies) to shape the terminals, it is advantageous to provide an axial offset between the attachment pin and the electrical crimping region of the shunt connector. With reference to the longitudinal section in FIG. 7, it appears that the sleeve 2m of the coupler 2′″ is sufficiently long for the crimping region 21s of the stripped core 11 and the attachment pin 2p to be axially offset along the axis X′X without axial overlap.

The invention is not limited to the embodiments that have been described and shown. In particular, the dimensions of the shunt connector can be adapted depending on the gauge and on the insulating sheath of the cables. The surface treatment of the inner wall of the shunt connectors can also be adapted by nickel-plating, tin-plating, etc. Moreover, all the installation techniques between the shunt connector and the structure, which allow for the production of both an electrical connection and a mechanical connection, by means of suitable installation means (multiple, vertical fasteners, or via a partition) may be used: screwing, riveting, soldering, welding, shrink-fitting, etc.).

Furthermore, conductive or non-conductive components may also replace the metal surface treatments or replace the lateral seals. Furthermore, in an embodiment involving conductive grease, the injection channel or the collection recess may be replaced with any other storage or injection means.

1-14. (canceled)

15. Method for the equipotential-bonding connection of a current-return network in an aircraft, this network comprising primary current-return networks that are longitudinal relative to the fuselage and remote from one another in terms of location, at least one of said networks being formed by transversely spaced elements, such that equipotential connections join the primary networks so that altogether they form one current-return network, wherein the connections are formed by aluminium cabling of large cross section that integrally forms an equipotential connection between the primary networks and between their transversely spaced elements, the devices being electrically connected as closely as possible to their location by direct intermediate connections that succeed one another along the equipotential connection without interrupting the cabling, which connections are produced by tight electrical and mechanical installation,
each interconnection having two impermeable regions that surround a central contact region by means of window-stripping.

16. Connection method according to claim 15, wherein each connection is installed on the cable by rigid connection techniques selected from among screwing, riveting, soldering, welding, crimping and shrink-fitting.

17. Connection method according to claim 15, wherein a conductive material is applied upon sheath stripping before each interconnection is installed.

18. Connection method according to claim 15, wherein a metal-surface treatment is applied to improve electrical contact and prevent oxidation.

19. Connection method according to claim 15, wherein each connection has an electrical installation region that is offset from a region for attaching the interconnection.

20. Current-return network in an aircraft, comprising primary current-return networks that are longitudinal relative to the fuselage and remote from one another in terms of location, at least one of said networks being formed by transversely spaced elements, such that equipotential connections join the primary networks so that altogether they form one current-return network, wherein the connections are formed by aluminium cabling of large cross section that integrally forms an equipotential connection between the primary networks and between their transversely spaced elements, the devices being electrically connected to the cable of the equipotential connection as closely as possible to their location by in-line equipotential shunt connectors comprising a substantially cylindrical metal sleeve for installation on the cable by rigid connection and an attachment means that extends the sleeve so as to be attached to a bracket for the device, said installation sleeve being composed of two end portions that each accommodate a seal and surround a central region for electrical contact with the cable having been pre-stripped in a window formed within the central region.

21. Network according to claim 20, wherein the rigid connection is a crimping by punch and die.

22. Network according to claim 20, wherein the end portions are crimped onto an insulating sheath of the cable using a tool of the type for aluminium terminals.

23. Network according to claim 20, wherein the sleeve has an inner wall coated with an anti-corrosion protective metal coating.

24. Network according to claim 20, wherein the inner surface of the sleeve and the stripped core of the cable have metal surface treatments.

25. Network according to claim 20, wherein the stripped core of the cable is coated with a conductive grease layer.

26. Network according to claim 25, wherein a recess is formed between the sleeve and the cable, and between the stripped window of the cable and at least one seal of an end portion of the sleeve so as to be able to receive an excess of grease formed during crimping without trapping this grease between the seal and the cable.

27. Network according to claim 25, wherein a channel is formed through the sleeve for injecting the amount of conductive grease so that its end is in communication with the electrical crimping region between the stripped window of the cable and the inner face of the sleeve, the crimping then being able to seal this channel after orienting the sleeve by means of notches.
